(19) United States
(12) Patent Application Publication
(10) Pub. No.: US 2011/0219544 A1
(43) Pub. Date: Sep. 15, 2011

(54) OSCILLATING BED

(76) Inventors: Howard Johnston, Scottsdale, AZ (US); Willard R. Wilson, Casa Grande, AZ (US)

(21) Appl. No.: 13/028,337

(22) Filed: Feb. 16, 2011

Related U.S. Application Data
(60) Provisional application No. 61/306,040, filed on Feb. 19, 2010.

(51) Int. Cl. A61G 7/008

(52) U.S. Cl. 5/609

(57) ABSTRACT

An oscillating bed includes a stand or base with spaced apart, head and foot upright members. A body supporting member generally defines the length and width of the bed and has a foot end and a head end defining a longitudinal axis and longitudinally extending rims along opposed sides with a curved surface extending lateral to the longitudinal axis between the foot end and the head end. The head upright member is pivotally attached to the head end and the foot upright member is pivotally attached to the foot end and supports the body supporting member relative to the stand for oscillatory movement. A rotary motor and drive apparatus are coupled to the body supporting member and convert rotary motion of the motor to oscillatory movement of the body supporting member about the longitudinal axis.

### CROSS-REFERENCE TO RELATED APPLICATION

This application claims the benefit of U.S. Provisional Application No. 61/306,040 filed 19 Feb. 2010.

### FIELD OF THE INVENTION

This invention relates to beds and, more particularly, to beds for bedridden patients.

### BACKGROUND OF THE INVENTION

In the field of health care, an avoidable complication is one that is the result of being confined to a bed for extended periods of time. Bedsores, also called pressure ulcers or decubitus ulcers, are areas of injured tissue that develop in people who are confined to a bed for extended periods of time or are unable to move for shorter periods of time. Bedsores are common in hospitals and nursing homes and in people bed ridden in their homes. A pressure ulcer is an injury caused by constant pressure to the skin and muscle. When a person cannot change position, pressure closes small blood vessels that nourish the skin and supply oxygen. Unless pressure is relieved and normal circulation resumes, the affected area soon begins to show signs of injury. The resulting wound can destroy tissue, fat, muscle and even lead to amputation and death. These injuries can range from mild, affecting the skin surface only, to severe when a deep decubitus ulcer reaches down to muscle and bone. Bedsores can occur in a short time. Pressure as small as 60 mm Hg applied to a body surface for 1-2 hours can initiate the process of skin breakdown.

To avoid this preventable injury, individuals (e.g. a nurse, care giver, doctor, etc.) must periodically move the patient to a different position to provide the respite required to allow drying and ease of pressure that can produce bedsores on the body. If dutifully performed at frequent intervals, movement of patients can prevent bedsore formation. However, this is a very time consuming and labor intensive procedure often passed over due to unforeseen circumstances, forgotten or simply neglected.

It would be highly advantageous, therefore, to remedy the foregoing and other deficiencies inherent in the prior art.

Accordingly, it is an object the present invention to provide a new and improved bed.

Another object of the present invention is to provide a new and improved bed that automatically and periodically moves a patient to prevent bed sores and the like.

### SUMMARY OF THE INVENTION

Briefly, to achieve the desired objects of the instant invention in accordance with a preferred embodiment thereof, provided is an oscillating bed including a stand or base with spaced apart, head and foot upright members. A body supporting member generally defines the length and width of the bed. The body supporting member has a foot end and a head end defining a longitudinal axis, and longitudinally extending rims along opposed sides with a curved surface extending lateral to the longitudinal axis between the foot end and the head end, and the curved surface defines a body supporting surface. The head upright member is pivotally attached to the head end of the body supporting member and the foot upright member is pivotally attached to the foot end of the body supporting member. The head and foot upright members support the body supporting member relative to the stand for oscillatory movement. A rotary motor and drive apparatus are coupled to the body supporting member so as to convert rotary motion of the motor to oscillatory movement of the body supporting member about the longitudinal axis.

The desired objects of the instant invention are further achieved in accordance with a specific embodiment of an oscillating bed including a stand or base with spaced apart, head and foot upright members. A body supporting member generally defines the length and width of the bed. The body supporting member has a foot end and a head end defining a longitudinal axis and longitudinally extending rims along opposed sides with a curved surface extending lateral to the longitudinal axis between the foot end and the head end. The curved surface defines a body supporting surface. The foot end includes a foot board that is substantially a continuation of the rims and the head end includes a head board. The head upright member is pivotally attached to the head board and the foot upright member is pivotally attached to the foot board. The head and foot upright members support the body supporting member relative to the stand for oscillatory movement. A stepper motor and drive apparatus are coupled to the body supporting member. The drive apparatus converts rotary motion of the motor to linear motion and the drive apparatus is coupled between the head board and the head upright member to provide oscillatory movement of the body supporting member about the longitudinal axis.

The desired objects of the instant invention are further achieved in accordance with another embodiment of an oscillating bed including a stand or base with spaced apart, head and foot upright members. A molded plastic body supporting member generally defines the length and width of the bed. The body supporting member has a foot end and a head end defining a longitudinal axis and a longitudinally extending rim along opposed sides with a curved surface extending lateral to the longitudinal axis between the foot end and the head end. The curved surface defines a body supporting surface. The foot end includes a foot board that is substantially a continuation of the rim and the head end includes a head board. The body supporting member is formed in a single piece with the curved surface generally arcuate along the width so that the longitudinally extending rims along opposed sides of the curved surface are higher than the center. The head upright member is pivotally attached to the head board and the foot upright member is pivotally attached to the foot board. The head and foot upright members support the body supporting member relative to the stand for oscillatory movement. A stepper motor and drive apparatus are coupled to the body supporting member. The drive apparatus converts rotary motion of the motor to linear motion and the drive apparatus is coupled between the head board and the head upright member to provide oscillatory movement of the body supporting member about the longitudinal axis.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is an isometric view of an oscillating bed in accordance with the present invention;

FIG. 2 is a foot end elevation view of the oscillating bed of FIG. 1;

FIG. 3 is a side elevation view of the oscillating bed of FIG. 1;

FIG. 4 is an isometric view of the oscillating bed of FIG. 1, with the bed pan removed to better illustrate components;

FIG. 5 is an end view of the oscillating bed of FIG. 4; and

FIG. 6 is an isometric view of the bed pan of the oscillating bed.

### DETAILED DESCRIPTION OF THE DRAWINGS

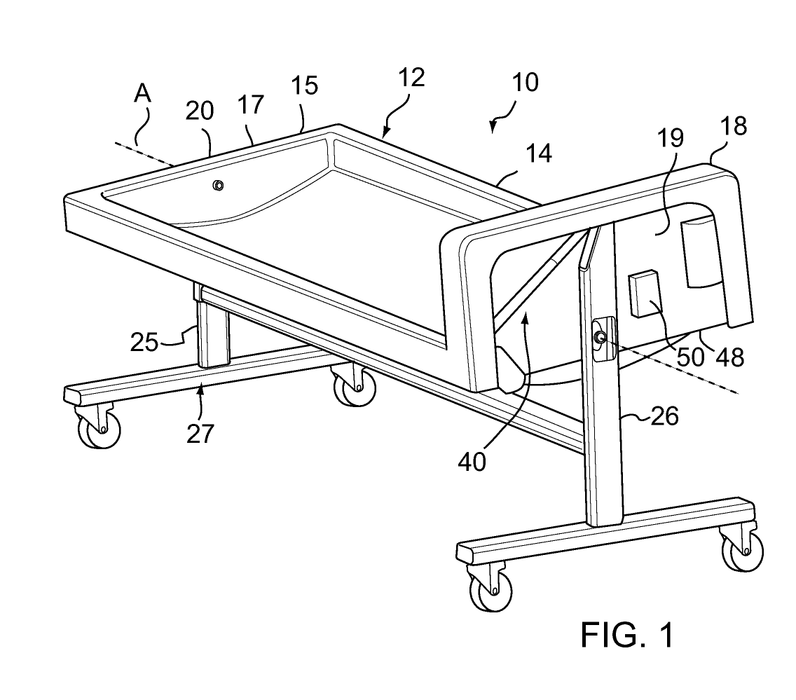

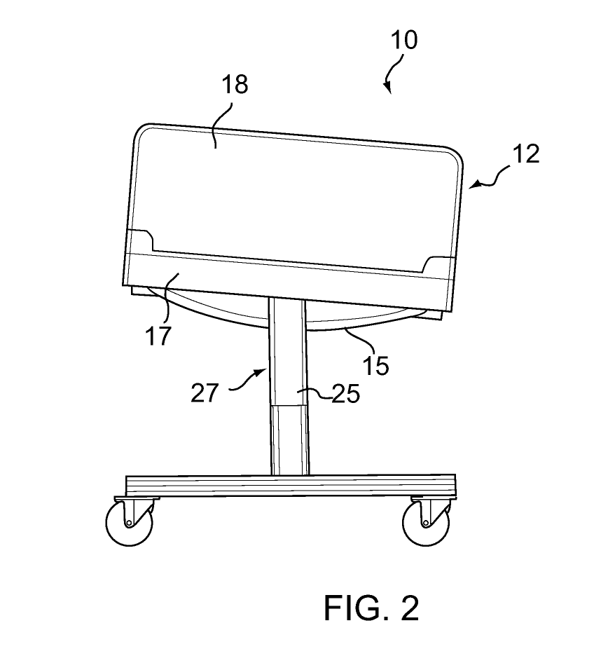

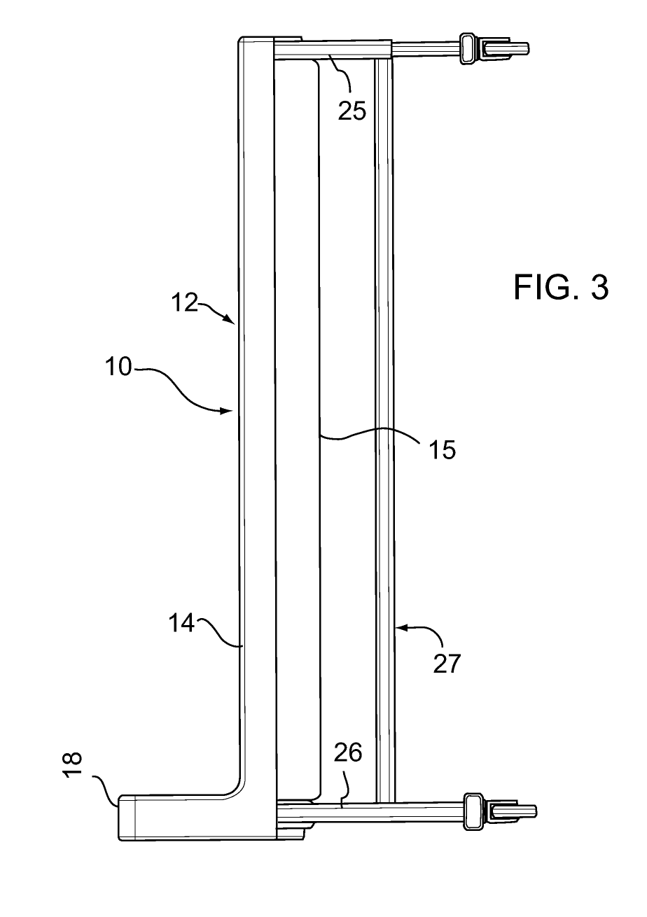

Turning now to the drawings in which like characters indicate corresponding parts throughout the various figures, FIGS. 1, 2 and 3 illustrate an oscillating bed 10 in accordance with the present invention. Bed 10 includes a body supporting member, also referred to as a bed pan, 12 that includes a rim 14 and a curved surface 15. Bed pan 12 generally defines the length (i.e. head to foot or longitudinal axis) and the width (i.e. side-to-side or transverse axis) of bed 10. Member 12 is formed of relatively hard or stiff material that does not bend or otherwise change shape in response to a body lying on it, such as fiberglass, roto-molded plastic, blow molded plastic, and the like. Also, member 12 is curved or arcuate, at curved surface 15, along the width so that the sides of surface 15 proximate rim 14 are higher than the center. It will of course be understood that a mattress or other pads can be placed on member 12 for the comfort of a patient in bed 10 and to further help relieve pressure on the individual's body.

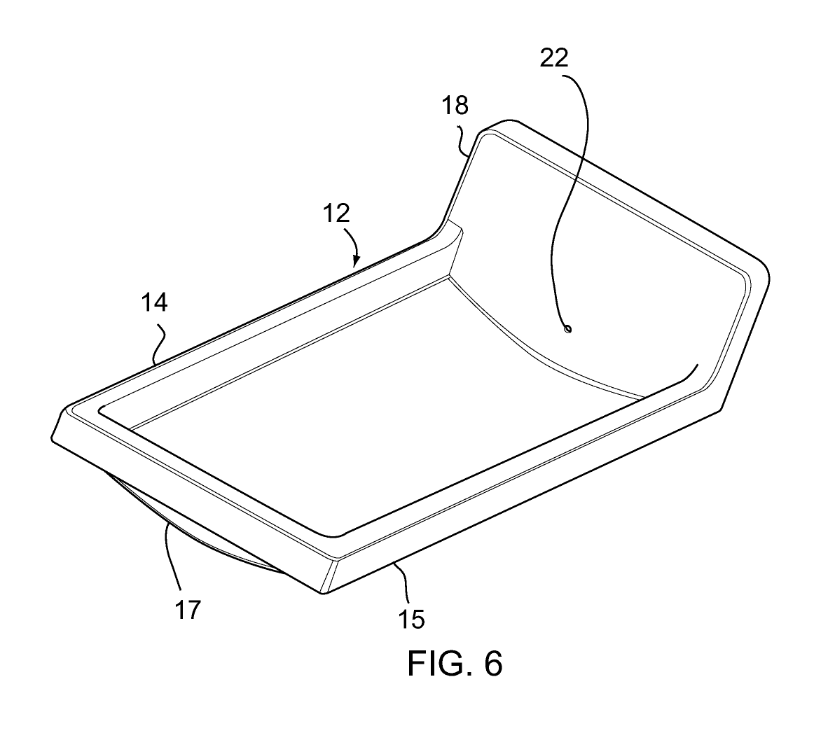

With additional reference to FIG. 6, member 12 further includes a foot end having a foot board 17 being substantially a continuation of rim 14, in this embodiment, and a head end having a head board 18 defining a void 19. In the present embodiment, rim 14, footboard 17 and head board 18 are double walled, with the bottom open. Void 19 of headboard 18 can be closed with a panel if desired. An aperture 20 is formed in the inner wall of foot board 17, and an aperture 22 is formed in the inner wall of head board 18 in communication with void 19. Apertures 20 and 22 are formed centrally in foot board 17 and head board 18, respectively, and define an axis of rotation A therebetween.

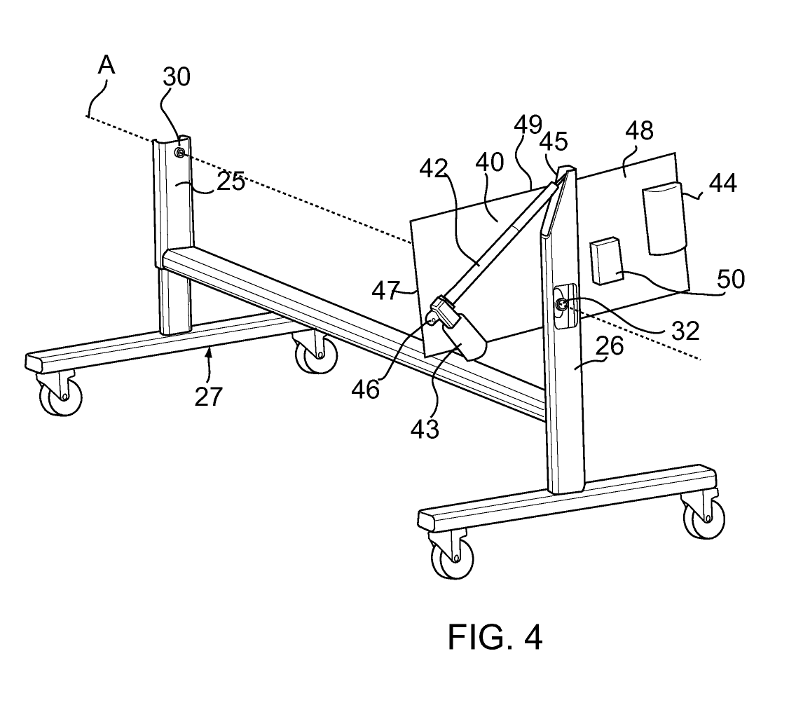

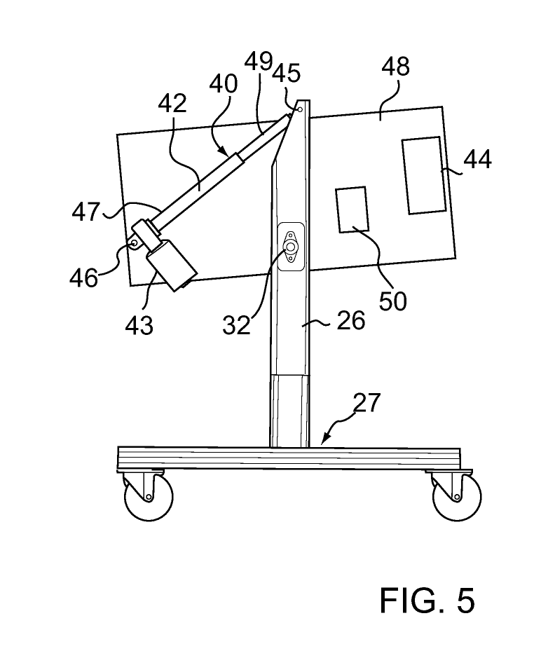

With additional reference to FIGS. 4 and 5, member 12 is supported at each of the foot and head ends by upright members 25 and 26, respectively, of a stand or base 27. In this preferred embodiment, stand 27 is wheeled to facilitate movement, but can be stationary, as desired. Upright members 25 and 26 are received in foot board 17 and head board 18, respectively, between the inner and outer walls. Upright member 25 terminates within foot board 17, and carries a pillow block bearing 30 secured to foot board 17 in aperture 20 and aligned with axis of rotation A. Upright member 26 terminates within head board 18, and carries a bearing 32 secured to head board 18 in aperture 22 and aligned with axis of rotation A. Upright member 26 extends upwardly beyond axis of rotation A for purposes which will be described presently. Thus, member 12 is coupled to stand 27 for pivotal movement about axis of rotation A at the foot end by bearing 30 coupled between upright 25 and foot board 17, and at the head end by bearing 32 coupled between upright 26 and head board 18.

A drive mechanism 40 is carried within void 19 of head board 18 and includes a linear actuator 42 and a stepper motor 43 powered by a power source 44. Linear actuator 42 is preferably a worm drive structure converting the rotational movement of stepper motor 43 to linear movement. In this embodiment, linear actuator 42 includes a tubular body 47 and a telescoping drive member 49 mounted within body 47 for relative telescoping action in response to relative rotary movement. Stepper motor 43 has a drive gear attached to the shaft for rotation therewith and the drive gear is meshed with a worm gear extending the length of drive member 49. It will be understood that as stepper motor 43 rotates or steps, drive member 49 telescopes out of or recedes into body 47. A number of different mechanical arrangements can be devised to convert the rotation of motor 43 into linear movement and thence into oscillatory movement of body supporting member 12.

In this preferred embodiment an end 45 of drive member 49 is pivotally coupled to the upper end of upright 26, spaced apart from bearing 32, and an end 46 of body 47 is pivotally coupled to a panel 48 affixed to head board 18 within void 19. End 46 is spaced from bearing 32 preferably proximate a side of panel 48. Motor 43 is coupled to body 47 proximate end 46 so as to drive linear actuator 42 between extended and retracted positions. The linear movement rotates member 12 about axis A in alternating directions, imparting an oscillatory motion to member 12. The speed and angle of the movement can be controlled by a control module 50 mounted on panel 48, in this embodiment.

Control module 50 is electrically connected to power source 44 and to motor 43 and supplies power to motor 43 in accordance with a program set or designed into control module 50. It will be understood that control module 50 can contain fixed circuitry with one program specifically designed to oscillate bed 10 in a predetermined manner, or one or more selectable programs varying in speed and amount of oscillation as well as any time between oscillations, or control module 50 can contain programmable circuitry for changing the oscillations, speed, duration, frequency, etc. to any desired or required program. Further, a preferred simplified embodiment is illustrated in which control module 50 and power source 44 are mounted on the rear surface of panel 48 and only require the power to be turned ON with a simplified movement schedule permanently programmed into control module 50. In this preferred embodiment member 12 is oscillated very slowly between a maximum clockwise point or position to a maximum counterclockwise point or position so as to continuously relieve pressure on a patient's body and assure normal circulation.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. An oscillating bed comprising:
a stand or base including spaced apart, head and foot upright members;
a body supporting member generally defining the length and width of the bed, the body supporting member having a foot end and a head end defining a longitudinal axis and longitudinally extending rims along opposed sides with a curved surface extending lateral to the longitudinal axis between the foot end and the head end, and the curved surface defining a body supporting surface;
the head upright member being pivotally attached to the head end of the body supporting member and the foot upright member being pivotally attached to the foot end of the body supporting member, the head and foot upright members supporting the body supporting member relative to the stand for oscillatory movement; and
a rotary motor and drive apparatus coupled to the body supporting member; the drive apparatus converting rotary motion of the motor to oscillatory movement of the body supporting member about the longitudinal axis.

2. An oscillating bed as claimed in claim 1 wherein the body supporting member is formed of relatively stiff material that does not bend or otherwise substantially change shape in response to a body lying on it.

3. An oscillating bed as claimed in claim 1 wherein the body supporting member is formed in a single piece and the curved surface is generally arcuate along the width so that the longitudinally extending rim along opposed sides of the curved surface are higher than the center.

4. An oscillating bed as claimed in claim 3 wherein the body supporting member is formed of a molded plastic.

5. An oscillating bed as claimed in claim 1 wherein the stand or base includes wheels.

6. An oscillating bed as claimed in claim 1 wherein the drive apparatus includes a stepper motor.

7. An oscillating bed as claimed in claim 1 wherein the drive apparatus includes a worm drive structure that converts rotational movement of the stepper motor to linear movement.

8. An oscillating bed as claimed in claim 7 wherein the worm drive structure includes a tubular body and a telescoping drive member mounted within the body for relative telescoping action in response to relative rotary movement.

9. An oscillating bed as claimed in claim 8 wherein one end of the tubular body is pivotally attached to one of the head upright member and the head end of the body supporting member and one end of the telescoping drive member is pivotally attached to the other of the head upright member and the head end of the body supporting member.

10. An oscillating bed as claimed in claim 8 wherein the telescoping drive member includes an elongated worm gear and the stepper motor is affixed to the tubular body and includes a gear mated and meshed with the elongated worm gear.

11. An oscillating bed comprising:
a stand or base including spaced apart, head and foot upright members;
a body supporting member generally defining the length and width of the bed, the body supporting member having a foot end and a head end defining a longitudinal axis, and longitudinally extending rims along opposed sides with a curved surface extending lateral to the longitudinal axis between the foot end and the head end, the curved surface defining a body supporting surface, and the foot end including a foot board being substantially a continuation of the rims and the head end including a head board;
the head upright member being pivotally attached to the head board and the foot upright member being pivotally attached to the foot board, the head and foot upright members supporting the body supporting member relative to the stand for oscillatory movement; and
a stepper motor and drive apparatus coupled to the body supporting member; the drive apparatus converting rotary motion of the motor to linear motion, and the drive apparatus being coupled between the head board and the head upright member to provide oscillatory movement of the body supporting member about the longitudinal axis.

12. An oscillating bed as claimed in claim 11 wherein the body supporting member is formed of relatively stiff material that does not bend or otherwise substantially change shape in response to a body lying on it.

13. An oscillating bed as claimed in claim 11 wherein the body supporting member is formed in a single piece and the curved surface is generally arcuate along the width so that the longitudinally extending rim along opposed sides of the curved surface are higher than the center.

14. An oscillating bed as claimed in claim 13 wherein the body supporting member is formed of a molded plastic.

15. An oscillating bed comprising:
a stand or base including spaced apart, head and foot upright members;
a molded plastic body supporting member generally defining the length and width of the bed, the body supporting member having a foot end and a head end defining a longitudinal axis, and longitudinally extending rims along opposed sides with a curved surface extending lateral to the longitudinal axis between the foot end and the head end, the curved surface defining a body supporting surface, the foot end including a foot board being substantially a continuation of the rims and the head end including a head board, and the body supporting member being formed in a single piece with the curved surface generally arcuate along the width so that the longitudinally extending rims along opposed sides of the curved surface are higher than the center;
the head upright member being pivotally attached to the head board and the foot upright member being pivotally attached to the foot board, the head and foot upright members supporting the body supporting member relative to the stand for oscillatory movement; and
a stepper motor and drive apparatus coupled to the body supporting member; the drive apparatus converting rotary motion of the motor to linear motion, and the drive apparatus being coupled between the head board and the head upright member to provide oscillatory movement of the body supporting member about the longitudinal axis.

16. An oscillating bed as claimed in claim 15 wherein the drive apparatus includes a worm drive structure that converts rotational movement of the stepper motor to linear movement.

17. An oscillating bed as claimed in claim 16 wherein the worm drive structure includes a tubular body and a telescoping drive member mounted within the body for relative telescoping action in response to relative rotary movement.

18. An oscillating bed as claimed in claim 17 wherein one end of the tubular body is pivotally attached to one of the head upright member and the head end of the body supporting member and one end of the telescoping drive member is pivotally attached to the other of the head upright member and the head end of the body supporting member.

19. An oscillating bed as claimed in claim 17 wherein the telescoping drive member includes an elongated worm gear and the stepper motor is affixed to the tubular body and includes a gear mated and meshed with the elongated worm gear.
